(19) United States
(12) Patent Application Publication
(10) Pub. No.: US 2024/0339257 A1
(43) Pub. Date: Oct. 10, 2024

(54) IMPULSE-WIRE MODULE AND METHOD FOR PRODUCING AN IMPULSE-WIRE MODULE

(71) Applicant: FRABA B.V., SG HEERLEN (NL)

(72) Inventor: MICHAEL LOEKEN, JUELICH (DE)

(73) Assignee: FRABA B.V., SG HEERLEN (NL)

(21) Appl. No.: 18/294,173

(22) PCT Filed: Aug. 3, 2022
(86) PCT No.: PCT/EP2022/071814

§ 371 Date: Feb. 1, 2024

(30) Foreign Application Priority Data
Aug. 13, 2021 (DE) 10 2021 121 065.8

(51) Int. Cl. H01F 27/28; H01F 27/29; H01F 41/04

(52) U.S. Cl. CPC H01F 27/2823; H01F 27/29; H01F 41/04

(57) ABSTRACT

An impulse wire module and a method for manufacturing thereof. The impulse wire includes a module housing which defines a housing chamber, a wire winding which is formed by a winding wire and which is arranged at least partially within the housing chamber, an impulse wire which extends at least partially within the wire winding, a contacting device which provides an external electrical contacting of the impulse wire module, and a material-locking connection. The contacting device is attached to the module housing and is electrically connected with the wire winding. The material-locking connection connects the winding wire with the contacting device. The method for manufacturing the impulse wire includes inserting the wire winding into the module housing, bringing the winding wire to the contacting device, and providing the material-locking connection between the winding wire and the contacting device.

### CROSS REFERENCE TO PRIOR APPLICATIONS

This application is a U.S. National Phase application under 35 U.S.C. § 371 of International Application No. PCT/EP2022/071814, filed on Aug. 3, 2022 and which claims benefit to German Patent Application No. 10 2021 121 065.8, filed on Aug. 13, 2021. The International Application was published in German on Feb. 16, 2023 as WO 2023/016885 A1 under PCT Article 21 (2).

### FIELD

The present invention is directed to an impulse wire module comprising a module housing which defines a housing chamber, a wire winding which is formed by a winding wire and which is arranged at least partially within the housing chamber, an impulse wire which extends at least partially within the wire winding, and a contacting device for external electrical contacting of the impulse wire module, which is attached to the module housing and which is electrically connected with the wire winding. The present invention is also directed to a method for manufacturing such an impulse wire module.

### BACKGROUND

Such impulse wire modules, which are also known as Wiegand modules, are, for example, used in magnet-based rotary angle measuring devices to detect an excitation magnetic field that is generated by an excitation magnet.

Such an impulse wire module is described in DE 10 2020 100 732 A1, wherein the contacting device comprises a connecting element around which the winding wire is wound in order to electrically connect the contacting device with the wire winding. The disclosed impulse wire module is made up of several parts, which allows for an automated winding of the winding wire around the connecting element. The manufacturing costs of the disclosed impulse wire module are, however, relatively high due to the complex multi-part structure.

### SUMMARY

An aspect of the present invention is to provide a cost-effective production of an impulse wire module.

In an embodiment, the present invention provides an impulse wire module and a method for manufacturing the impulse wire module. The impulse wire module includes a module housing which defines a housing chamber, a wire winding which is formed by a winding wire and which is arranged at least partially within the housing chamber, an impulse wire which extends at least partially within the wire winding, a contacting device which provides an external electrical contacting of the impulse wire module, and a material-locking connection. The contacting device is attached to the module housing and is electrically connected with the wire winding. The material-locking connection is configured to connect the winding wire with the contacting device. The method for manufacturing the impulse wire includes inserting the wire winding into the module housing, bringing the winding wire to the contacting device, and providing the material-locking connection between the winding wire and the contacting device.

### BRIEF DESCRIPTION OF THE DRAWINGS

The present invention is described in greater detail below on the basis of embodiments and of the drawings in which:

FIG. 1 shows a plan view of a bottom side of an impulse wire module according to the present invention;

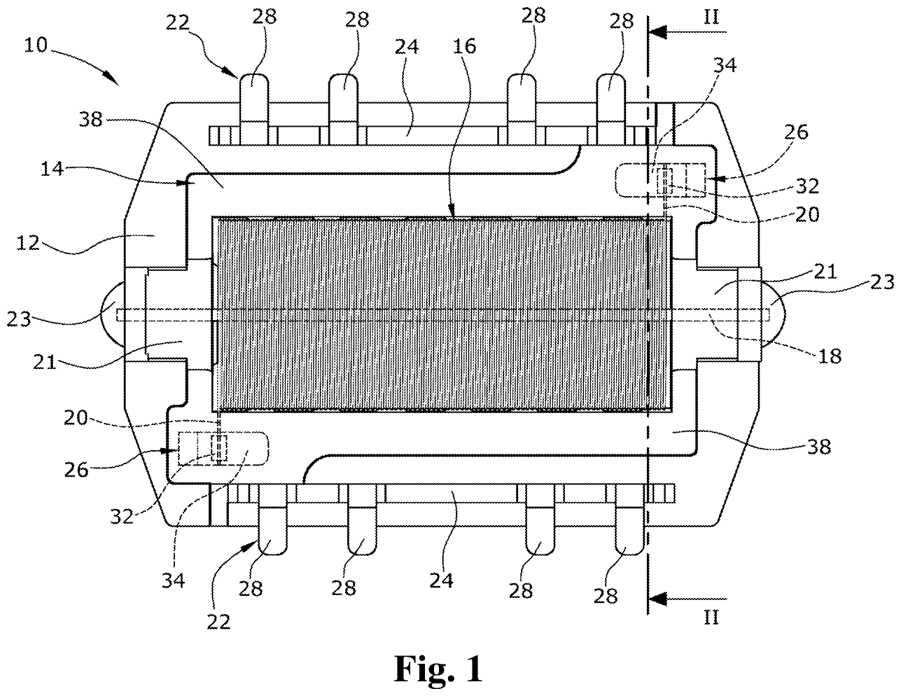

FIG. 2 shows a cross-sectional view of the impulse wire module of FIG. 1 along the drawn line II-II; and

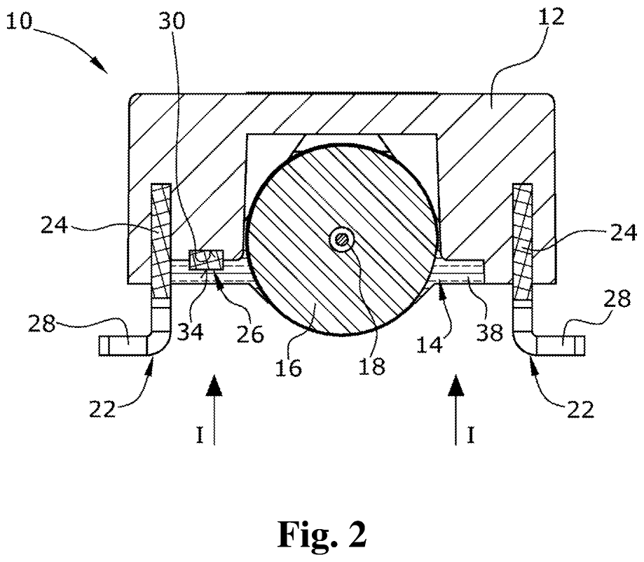

FIG. 3 shows a contacting device of the impulse wire module of FIG. 1.

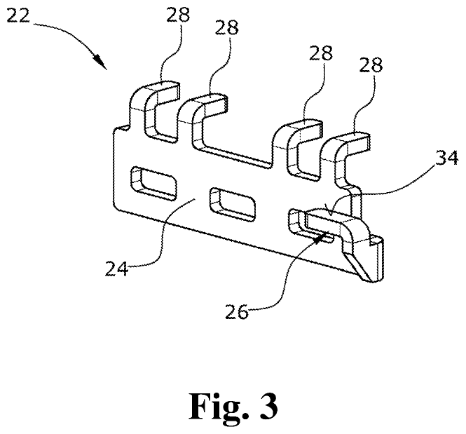

### DETAILED DESCRIPTION

The impulse wire module according to the present invention comprises a module housing which defines a housing chamber. The module housing is typically made of plastic and is an injection molded part. The module housing is typically designed to be substantially trough-shaped and consequently defines a housing chamber which is open on one side (typically on a bottom side of the module housing). The housing chamber typically comprises a cylinder-segment-shaped section for receiving the wire winding. The module housing can comprise special structures for aligning and positioning the module housing during assembly.

The impulse wire module according to the present invention further comprises a wire winding and an impulse wire. The wire winding is formed by a winding wire and is arranged at least partially within the housing chamber. The wire winding can, for example, be designed as a so-called air coil that does not have a winding core. The impulse wire extends at least partially within the wire winding, which means that the wire winding at least partially surrounds the impulse wire radially. An inner diameter of the coil can, for example, be slightly larger than an outer diameter of the impulse wire so that the impulse wire is positioned and supported by the wire winding in the radial direction. A ferritic element is typically arranged on both axial sides of the wire winding via which each end of the impulse wire is supported. The ferritic elements are attached to the module housing, whereby the ferritic elements can, for example, be overmolded by the module housing. The impulse wire can, for example, be adhesively attached to the two ferritic elements via a relatively soft adhesive which hardens under UV light, for example, silicone. The impulse wire is magnetically bistable and is also known as Wiegand wire. Under the influence of an external magnetic field, the direction of magnetization of the impulse wire inverts abruptly, which generates a short voltage pulse in the wire winding.

The impulse wire module according to the present invention further comprises at least one contacting device for an external electrical contacting of the impulse wire module. The contacting device is attached to the module housing, wherein the contacting device can, for example, be overmolded by the module housing. The contacting device is electrically connected with the wire winding so that voltage pulses which are generated in the wire winding can be externally detected via the contacting device. The contacting device typically comprises several contacting elements, which are also known as contact legs or contact pins, which are arranged at a defined distance from each other in order to allow the impulse wire module to be mounted on a standardized circuit board. The contacting elements can, for example, be arranged on the bottom side of the module housing and be designed to mount on the surface of a printed circuit board so that the impulse wire module is designed as a so-called “Surface-Mounted Device” (SMD).

According to the present invention, the winding wire is connected with the contacting device via a material-locking connection. The material-locking connection can in particular be a welded connection or a soldered connection. The material-locking connection can, however, in principle be any type of material-locking connection that provides an electrical connection between the winding wire and the contacting device. The material-locking connection can in principle be arranged in any area of the contacting device. The contacting device can, for example, comprise a specially configured connection area for forming the material-locking connection with the winding wire. The winding wire can, for example, be connected with the contacting device only via the material-locking connection, whereby it is certainly conceivable that the material-locking connection can be surrounded by a protective layer, for example, a varnish or a potting compound, to protect it from environmental influences. The protective layer does not here, however, provide any significant contribution to the connection between the winding wire and the contacting device, but only serves to protect the material-locking connection. The material-locking connection provides a reliable connection between the winding wire and the contacting device which can relatively easily be manufactured in an automated manner using appropriate machines. This allows for a particularly cost-effective manufacturing of the impulse wire module according to the present invention.

The contacting device can, for example, be tinned, i.e., coated with tin, at least in the connection area where the material-locking connection between the winding wire and the contacting device is arranged. This allows for a particularly simple and reliable manufacturing of the material-locking connection, for example, via thermocompression welding or soldering.

The material-locking connection between the winding wire and the contacting device is advantageously arranged within the housing chamber with the housing chamber being filled with a potting compound so that the material-locking connection between the winding wire and the contacting device is surrounded by the potting compound. The potting compound reliably protects the material-locking connection from environmental influences, in particular from moisture and mechanical impact. The potting compound furthermore reliably fixes the wire winding and the impulse wire within the housing chamber and also protects them from environmental influences. This provides a particularly durable impulse wire module. The potting compound can, for example, harden under UV light in order to allow the potting compound to harden relatively quickly and reliably.

The contacting device can, for example, comprise a main body which is embedded into the module housing, and a connecting element which protrudes from the module housing and on which the material-locking connection with the winding wire is arranged. The connecting element can, for example, be formed integrally with the main body. The main body, which is embedded into the module housing, provides a reliable attachment of the contacting device to the housing. The main body can, for example, be completely or at least partially overmolded by the module housing. Several contacting elements are additionally typically formed on the main body which also protrude from the module housing and which are used for external electrical contacting of the impulse wire module. The connecting element can, for example, be arranged on a side of the main body that faces the wire winding. The connecting element, which protrudes from the module housing, is easily accessible and allows for an easy manufacturing of the material-locking connection with the winding wire.

The connecting element can, for example, be bent down so that it abuts against a surface of the module housing. Because the connecting element is bent down, a relatively large connection surface for manufacturing the material-locking connection is provided in a simple manner. The connecting element, and thus also the material-locking connection with the winding wire that is arranged thereon, is furthermore arranged relatively close to the module housing and is thus relatively well protected against external mechanical influences. The surface of the module housing against which the connecting element abuts can, for example, be formed within the housing chamber so that the connecting element and the material-locking connection to the winding wire arranged thereon are arranged within the housing chamber.

The impulse wire module advantageously comprises a further contacting device which is electrically connected with the wire winding, wherein the winding wire is connected with the further contacting device via a further material-locking connection. The two contacting devices are typically arranged on opposite lateral sides of the wire winding and are each connected with one end of the winding wire so that the voltage pulses generated in the wire winding can be externally detected in a simple manner via the two separate contacting devices. The two contacting devices can, for example, be identically designed so that the same component can be used for both contacting devices.

The method for manufacturing an impulse wire module according to the present invention comprises the following method steps:
inserting the wire winding into the module housing;
bringing the winding wire to the contacting device; and
manufacturing the material-locking connection between the winding wire and the contacting device.

The wire winding is manufactured in an appropriate winding machine, wherein a sufficiently long connection section is provided at both ends of the wire winding for connecting the wire winding with the contacting device. The wire winding is inserted into the module housing as a prefabricated component.

The connection section of the winding wire is subsequently brought to the contacting device, in particular to the connection area of the contacting device.

The material-locking connection between the winding wire and the contacting device is then made via a suitable process, for example, via a welding process or a soldering process, in order to permanently connect the winding wire with the contacting device in an electrically conductive manner. A part of the winding wire that protrudes on a side of the connection area of the contacting device facing away from the wire winding is then typically cut off. The winding wire can, for example, be attached to the contacting device only via the material-locking connection after the material-locking connection has been made.

The material-locking connection between the winding wire and the contacting device is advantageously made in an automated manner by an appropriately configured machine. This allows for a particularly cost-effective manufacturing of the impulse wire module.

The material-locking connection between the winding wire and the contacting device can, for example, be made by thermowelding, for example, by thermocompression welding. Thermowelding machines are relatively inexpensive and allow the manufacturing of relatively small welds. This allows for a cost-effective and reliable manufacturing of the impulse wire module.

After the material-locking connection between the winding wire and the contacting device has been made, the housing chamber of the module housing is advantageously filled with a potting compound so that the material-locking connection between the winding wire and the contacting device is surrounded by the potting compound. This provides for a particularly durable impulse wire module.

After filling the housing chamber, the potting compound can, for example, be hardened relatively quickly and reliably by irradiation with UV light.

An embodiment of an impulse wire module according to the present invention is described below with reference to the enclosed drawings.

The drawings show an impulse wire module 10 with a module housing 12 which defines a housing chamber 14. In the present embodiment, the module housing 12 is a substantially trough-shaped injection-molded part made of plastic so that the housing chamber 14 is open on the bottom side of the module housing 12.

The impulse wire module 10 further comprises a wire winding 16 and an impulse wire 18 which extends through the wire winding 16 in an axial direction. The impulse wire 18 is thus radially surrounded by the wire winding 16 in a central region. The wire winding 16 is formed by a winding wire 20 and is partially arranged within the housing chamber 14. In the present embodiment, the wire winding 16 is designed as an air coil and is provided with an inner diameter that is slightly larger than an outer diameter of the impulse wire 18 so that the impulse wire 18 is positioned and supported in the radial direction by the wire winding 16. A ferritic element 21 is arranged at both axial ends of the wire winding 16, into which ferritic element 21 one axial end of the impulse wire 18 extends. In the present embodiment, two ferritic elements 21 are overmolded by the module housing 12 and the two ends of the impulse wire 18 are each attached to the respective ferritic element 21 via an adhesive connection 23. The adhesive connections 23 in the present embodiment consist of a relatively soft material that hardens under UV light, in particular silicone.

In the present embodiment, the impulse wire module 10 comprises two identical contacting devices 22, each of which is designed in one piece, for an external electrical contacting of the impulse wire module 10. The two contacting devices 22 in the present embodiment are completely tinned, i.e., are completely coated with tin. The two contacting devices 22 are arranged on opposite sides of the wire winding 16 and each comprise a main body 24, a connecting element 26, and, in the present embodiment, four contacting elements 28. The two contacting devices 22 in the present embodiment are overmolded by the module housing 12 so that the main bodies 24 of the two contacting devices 22 are each embedded into a side wall of the module housing 12, and so that the connecting elements 26 and the contacting elements 28 of the two contacting devices 22 each protrude from the bottom side of the module housing 12.

In the present embodiment, the connecting elements 26 of the two contacting devices 22 are each bent down so that they abut against a surface 30 of the module housing 12 which is formed within the housing chamber 14, and so that they are each arranged completely within the housing chamber 14. The connecting elements 26 are each electrically connected with one end of the winding wire 20 via a material-locking connection 32 so that the two contacting devices 22 are each electrically connected with one side of the wire winding 16. The winding wire 20 is attached to the respective contacting devices 22 only via the material-locking connection 32. The material-locking connections 32 are each arranged on a connection area 34 of the connecting elements 26 which is defined by the surface 30 of the connecting element 26 that faces away from the surface 30 of the module housing 12.

The housing chamber 14 in the present embodiment is completely, i.e., up to a housing bottom edge, filled with a potting compound 38 so that the connecting elements 26 and the material-locking connections 32 that are arranged on the connection areas 34 of the connecting elements 26 are each surrounded by the potting compound 38. The potting compound 38 in the present embodiment example hardens under UV light.

During the manufacturing of the impulse wire module 10, the wire winding 16 is inserted into the housing chamber 14 of the module housing 12 as a prefabricated component, and the two ends of the winding wire 20 which forms the wire winding 16 are each brought to the connection area 34 of the connecting element 26 of the respective contacting device 22.

The material-locking connections 32 between the two ends of the winding wire 20 and the respective contacting device 22 are (in the present embodiment in a completely automated manner via thermocompression welding) made in order to electrically connect the wire winding 20 with the two contacting devices 22.

After the wire winding 16 has been inserted into the module housing 12, the impulse wire 18 is inserted into the wire winding 16 and adhesively connected with the two ferritic elements 21.

The housing chamber 14 is completely filled with liquid potting compound 38 so that the connecting elements 26 and the material-locking connections 32 arranged thereon are surrounded by the potting compound 38. The potting compound 38 is hardened in a controlled manner by irradiation with UV light.

The present invention is not limited to embodiments described herein; reference should be had to the appended claims.

### LIST OF REFERENCE NUMERALS

10 impulse wire module
12 module housing
14 housing chamber
16 wire winding
18 impulse wire
20 winding wire
21 ferritic elements
22 contacting devices
23 adhesive connections
24 main body
26 connecting elements
28 contacting elements
30 surface
32 material-locking connection
34 connection area
38 potting compound

What is claimed is:

1-11. (canceled)

12: An impulse wire module comprising:
a module housing which defines a housing chamber;
a wire winding which is formed by a winding wire and which is arranged at least partially within the housing chamber;
an impulse wire which extends at least partially within the wire winding;
a contacting device which provides an external electrical contacting of the impulse wire module, the contacting device being attached to the module housing and being electrically connected with the wire winding; and
a material-locking connection which is configured to connect the winding wire with the contacting device.

13: The impulse wire module as recited in claim 12, wherein the contacting device is tinned at least in a connection area where the material-locking connection is arranged.

14: The impulse wire module as recited in claim 12, wherein,
the material-locking connection is arranged within the housing chamber, and
the housing chamber is filled with a potting compound so as to surround the material-locking connection.

15: The impulse wire module as recited in claim 12, wherein the contacting device comprises,
a main body which is embedded into the module housing, and
a connecting element which protrudes from the module housing and on which the material-locking connection is arranged.

16: The impulse wire module as recited in claim 15, wherein the connecting element is bent down to abut against a surface of the module housing.

17: The impulse wire module as recited in claim 12, further comprising:
a further contacting device which is electrically connected with the wire winding; and
a further material-locking connection,
wherein,
the winding wire is connected with the further contacting device via the further material-locking connection.

18: A method for manufacturing the impulse wire module as recited in claim 12, the method comprising:
inserting the wire winding into the module housing;
bringing the winding wire to the contacting device; and
providing the material-locking connection between the winding wire and the contacting device.

19: The method as recited in claim 18, wherein the material-locking connection is provided in an automated manner.

20: The method as recited in claim 18, wherein the material-locking connection is provided via a thermal welding.

21: The method as recited in claim 18, wherein, after the providing of the material-locking connection, the method further comprises:
filling the housing chamber with a potting compound so as to surround the material-locking connection.

22: The method as recited in claim 21, wherein the potting compound is hardened via an irradiation with UV light.
